(19) United States
(12) Patent Application Publication
(10) Pub. No.: US 2019/0181713 A1
(43) Pub. Date: Jun. 13, 2019

(54) DRIVE MOTOR FOR VEHICLE

(71) Applicants: Hyundai Motor Company, Seoul (KR); Kia Motors Corporation, Seoul (KR)

(72) Inventors: Kyungsoo Park, Daejeon (KR); Hyoungjun Cho, Suwon (KR); Sanghoon Moon, Yongin (KR); Suhyun Bae, Daegu (KR); Yong Jae Lee, Hwaseong (KR); Nyeonhan Hong, Donghae (KR); Jai Hak Kim, Gunpo (KR); Jung Shik Kim, Seoul (KR)

(21) Appl. No.: 16/163,097

(22) Filed: Oct. 17, 2018

(30) Foreign Application Priority Data
Dec. 11, 2017 (KR) 10-2017-0169268
Aug. 2, 2018 (KR) 10-2018-0090357

(51) Int. Cl. H02K 3/42; H02K 3/30; H02K 3/38; H02K 1/16

(52) U.S. Cl. CPC H02K 3/42; H02K 3/30; B60Y 2200/91; H02K 1/16; H02K 3/38

(57) ABSTRACT

A drive motor for a vehicle includes: a stator having a wound stator coil; a rotor that is spaced from the stator by a gap and is rotatably disposed in the stator; and a shielding film that is disposed between the stator coil and the rotor and is configured to shield a parasitic capacitance between the stator and the rotor.

### CROSS-REFERENCE TO RELATED APPLICATION(S)

This application claims under 35 U.S.C. § 119(a) the benefit of Korean Patent Application No. 10-2017-0169268 filed in the Korean Intellectual Property Office on Dec. 11, 2017 and Korean Patent Application No. 10-2018-0090357 filed in the Korean Intellectual Property Office on Aug. 2, 2018, the entire contents of which are incorporated herein by reference.

### BACKGROUND

### (a) Technical Field

The present disclosure relates to an electric power driven vehicle, and more particularly, to a shielding structure of a drive motor capable of suppressing generation of a shaft current of the drive motor in the vehicle.

### (b) Description of the Related Art

Recently, electric powered eco-friendly vehicles, including electric vehicles and fuel cell vehicles, have been developed. Each vehicle includes an electric motor that is a drive motor as a drive source for obtaining a rotational force by electric energy, instead of an internal combustion engine such as an engine.

The drive motor includes a motor housing, a stator fixedly installed inside the motor housing, and a rotor rotating around a rotation shaft that is a driving shaft. A gap is disposed between the stator and the rotor.

The drive motor is required to have high efficiency and high output density. In particular, the electric vehicle needs to obtain all the power of the vehicle from the drive motor, and therefore, a further improved torque and output are required, as compared to existing hybrid electric vehicles, for example.

The drive motor must be designed to be smaller and to exhibit high torque density and high output density, in order to generate a high level of torque and output within a limited vehicle space. Thus, the drive motor may be vulnerable to electromagnetic interference and leakage problems because internally higher electromagnetic energy acts in the confined space.

Typically, one of the electromagnetic interference and leakage problems is a shaft current. When a three-phase inverter driving the drive motor performs high-speed switching control, a harmonic noise voltage (e.g., a common voltage) is generated.

An electric field caused by the common voltage moves a free electron of the rotor steel plate to generate the shaft current in the rotation shaft. That is, the harmonic noise voltage induces a voltage across the shaft of the rotor using a parasitic capacitance between the stator and the rotor to generate the shaft current.

The shaft current generated in the shaft of the rotor causes a potential difference between an inner race and an outer race of a bearing when the shaft current flows along the shaft or through the bearing to the motor housing, and a discharge mechanism inside the bearing causes the bearing erosion (or the bearing electrolytic corrosion). The erosion seriously affects durability of the drive motor so that the bearing is damaged.

In addition, the shaft current flows to a reducer along the shaft of the rotor, which may generate amplitude modulation (AM) noise to cause AM radio quality problems.

The above information disclosed in this Background section is only for enhancement of understanding of the background of the disclosure and therefore it may contain information that does not form the prior art that is already known in this country to a person of ordinary skill in the art.

### SUMMARY

The present disclosure provides a drive motor capable of suppressing a parasitic capacitance between a stator and a rotor using a simple configuration.

An exemplary embodiment of the present disclosure may provide the drive motor, including: a stator having a wound stator coil; a rotor that is spaced from the stator by a gap and is rotatably disposed in the stator; and a shielding film that is disposed between the stator coil and the rotor and is configured to shield a parasitic capacitance between the stator and the rotor.

The stator may include: stator teeth protruding in a radial direction at regular intervals along a circumferential direction; and stator shoes integrally formed with the stator teeth and facing the rotor.

The stator coil may be wound on the stator tooth in a slot between the stator teeth.

The shielding film may be disposed in an opening area between both ends of the stator shoes adjacent to each other.

The shielding film may seal the opening area along an axial direction of the rotor and may be attached to both ends of the stator shoes adjacent to each other.

The shielding film may be made of an electrically conductive nonmagnetic material.

The shielding film may be made of the electrically conductive nonmagnetic material having a conductivity of 10⁶ (1/Ωm) or more and a magnetic permeability of 2 (H/m) or less.

The shielding film may be made of a material selected from the group consisting of: copper, aluminum, and silver.

A thickness of the shielding film may be greater than or equal to 0.1 mm and less than or equal to 0.3 mm.

Another exemplary embodiment of the present disclosure may provide the drive motor, including: a stator; and a rotor. The stator may include stator teeth protruding in a radial direction and disposed between slots along a circumferential direction, stator shoes integrally formed with the stator teeth and facing the rotor, and a stator coil wound on a stator tooth of the stator teeth in the slots. A shielding film may be disposed in an opening area between both ends of the stator shoes adjacent to each other and may shield a parasitic capacitance between the stator and the rotor.

The shielding film may seal the opening area along an axial direction of the rotor and may be attached to both ends of the stator shoes adjacent to each other.

The shielding film may be made of an electrically conductive nonmagnetic material.

Another exemplary embodiment of the present disclosure may provide the drive motor, including: a stator having a stator coil wound around a stator tooth of stator teeth that protrude in a radial direction and are disposed between slots along a circumferential direction; a rotor that is spaced from the stator by a gap and is rotatably disposed in the stator; a coil fixing member that is installed in a slot of the slots, is configured to fix the stator coil, and includes an insulating material; and a shielding film that is disposed on the coil fixing member between the stator teeth adjacent to each other and is configured to shield a parasitic capacitance between the stator coil and the rotor.

The stator may include stator shoes integrally formed with the stator teeth and facing the rotor. The shielding film may be attached to the coil fixing member in an opening area between both ends of the stator shoes adjacent to each other.

The coil fixing member may include: a first portion supporting a first stator tooth of the stator teeth in the slot; a second portion supporting a second stator tooth of the stator teeth that is adjacent to the first stator tooth in the slot; and a third portion disposed in the opening area. The shielding film may be attached to an opening surface of the third portion along an axial direction of the rotor.

The stator may include stator shoes integrally formed with the stator teeth and facing the rotor. The coil fixing member may include: a first portion supporting a first stator tooth of the stator teeth in the slot; a second portion supporting a second stator tooth of the stator teeth that is adjacent to the first stator tooth in the slot; and a third portion disposed in an opening area between both ends of the stator shoes adjacent to each other. The shielding film may be attached to a surface that faces the gap and is constituted by the first portion, the second portion and the third portion along an axial direction of the rotor.

The stator may include stator shoes integrally formed with the stator teeth and facing the rotor. The coil fixing member may include: a first portion supporting a first stator tooth of the stator teeth in the slot; a second portion supporting a second stator tooth of the stator teeth that is adjacent to the first stator tooth in the slot; and a third portion disposed in an opening area between both ends of the stator shoes adjacent to each other. The shielding film may be attached to a surface that faces the slot and is constituted by the first portion, the second portion and the third portion along an axial direction of the rotor.

The shielding film may be made of an electrically conductive nonmagnetic material.

The exemplary embodiment of the present disclosure may constitute the shielding film in the opening area of the stator coil between the stator and the rotor so that the shielding film is configured to shield the parasitic capacitance between the stator coil and the rotor.

Therefore, a magnitude of the parasitic capacitance between the stator coil and the rotor may be reduced so that a shaft current in a shaft of the rotor is reduced by reducing a current delivered to the rotor.

Thus, the shielding film may reduce the shaft current in the shaft of the rotor so that it is possible to prevent bearing erosion damage caused by an abnormal discharge phenomenon in which an electric spark occurs and to mitigate electromagnetic interference (e.g., amplitude modulation (AM) noise) due to the shaft current.

Further, the effects which may be obtained or predicted by the exemplary embodiment of the present disclosure will be directly or implicitly disclosed in the detailed description of the exemplary embodiments of the present disclosure. That is, various effects which are predicted by the exemplary embodiments of the present disclosure will be disclosed in the detailed description to be described below.

### BRIEF DESCRIPTION OF THE DRAWINGS

While the drawings are described in connection with what is presently considered to be practical exemplary embodiments, it is to be understood that the disclosure is not limited to the disclosed drawings.

FIG. 1 is a schematic view showing a drive motor according to an exemplary embodiment of the present disclosure.

FIG. 2 is a view schematically showing a shielding structure of the drive motor according to an exemplary embodiment of the present disclosure.

FIGS. 3 and 4 are views showing a shielding film applied to the drive motor according to an exemplary embodiment of the present disclosure.

FIG. 5 is a view schematically showing a shielding structure of the drive motor according to another exemplary embodiment of the present disclosure.

### DETAILED DESCRIPTION OF THE EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

The present disclosure will be described more fully hereinafter with reference to the accompanying drawings, in which exemplary embodiments of the disclosure are shown. As those skilled in the art would realize, the described embodiments may be modified in various different ways, all without departing from the spirit or scope of the present disclosure.

Portions having no relation with the description will be omitted in order to explicitly explain the present disclosure, and the same reference numerals will be used for the same or similar elements throughout the specification.

In the drawings, size and thickness of each element is approximately shown for better understanding and ease of description. Therefore, the present disclosure is not limited to the drawings, and the thicknesses of layers, films, panels, regions, etc., are exaggerated for clarity.

Further, in the following detailed description, names of constituents, which are in the same relationship, are divided into “the first”, “the second”, and the like, but the present disclosure is not limited to the order in the following description.

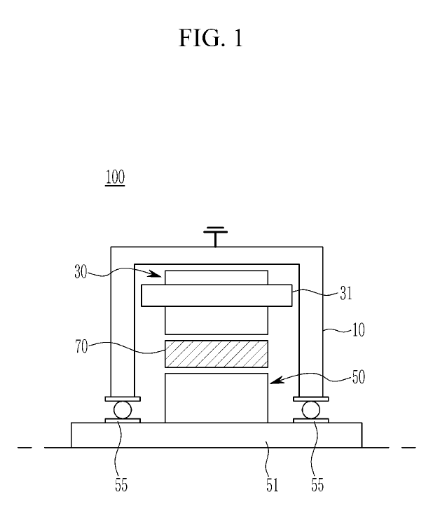

FIG. 1 is a schematic view showing a drive motor according to an exemplary embodiment of the present disclosure.

Referring to FIG. 1, the drive motor 100 may be an electric power source of an environmentally friendly vehicle such as an electric vehicle or a fuel cell vehicle.

The drive motor 100 may be a motor of a hybrid vehicle (e.g., a hybrid electric vehicle (HEV) or a plug-in hybrid electric vehicle (PHEV)) using a driving force of an engine and an electric power. The drive motor 100 may be a drive motor for a medium-sized hybrid vehicle that is fixedly mounted on an automatic transmission.

For example, the drive motor 100 may include a permanent magnet synchronous motor (PMSM) or a wound rotor synchronous motor (WRSM).

However, it should be understood that the present disclosure is not limited to the drive motor of the environmentally friendly vehicle and a technical idea of the present disclosure may be applied to a drive motor used in various industrial fields.

The drive motor 100 includes a stator 30 fixed to an inside of a motor housing 10 and a rotor 50 rotating around a rotation shaft 51 that is a driving shaft. A gap may be disposed between the stator and the rotor. For example, the drive motor 100 may be an inner rotor type synchronous motor in which the rotor 50 is disposed inside the stator 30.

The stator 30 may have a cylindrical shape as a whole. A stator coil 31 may be wound in the stator 30. The rotation shaft 51 may be rotatably coupled to the motor housing 10 through bearings 55 on front and rear sides.

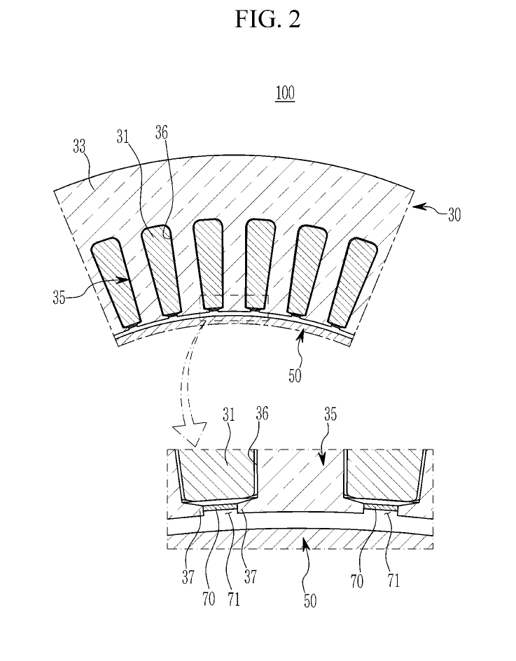

FIG. 2 is a view schematically showing a shielding structure of the drive motor according to an exemplary embodiment of the present disclosure.

A circumferential direction of the stator 30 is defined as a circumferential direction, and a direction in which the rotation shaft is coupled to the rotor 50 perpendicular to a plane on which the stator 30 and the rotor 50 are placed is defined as an axial direction (e.g., a shaft direction). A direction toward inner centers of the stator and the rotor is defined as a radial direction.

Referring to FIGS. 1 and 2, the stator 30 includes a stator core (or a core body) 33 in which a plurality of electrical steel sheets are stacked. Stator teeth 35 may be formed in the stator core 33 and may protrude in the radial direction at regular intervals along the circumferential direction. A stator shoe 37 may be formed at a radial center side of a stator tooth 35 so as to face an outer diameter surface of the rotor 50. A gap may be disposed between the stator shoe 37 and the outer diameter surface.

Slots 36 open to the radial center side may be formed between the stator teeth 35. That is, the slots 36 may be formed to be open to the outer diameter side of the rotor 50.

The stator coil 31 may be wound on the stator teeth 35 in a slot 36. For example, the stator coil 31 may include a rectangular coil (e.g., a copper wire of a hairpin type) or a round coil.

The rotor 50 may be a rotor of a permanent magnet type drive motor in which a permanent magnet is embedded in a rotor core or a rotor of a field winding drive motor in which a rotor coil is wound around a rotor core. Since a configuration of the rotor 50 is well known in a relevant field of technology, a more detailed description of the configuration will be omitted herein.

When a three-phase inverter driving the drive motor 100 performs high-speed switching control, a harmonic noise voltage may be generated. The harmonic noise voltage may induce a voltage across the shaft 51 of the rotor 50 using a parasitic capacitance between the stator 30 and the rotor 50 to generate a shaft current in the shaft 51.

The shaft current may be discharged from the rotation shaft 51 to the motor housing 10 through the bearings 55. In this case, the bearings 55 may be damaged due to an abnormal electric current in a form of a spark. When the shaft current is discharged to a reducer of the vehicle along the rotation shaft 51, the shaft current may cause amplitude modulation (AM) noise.

The drive motor 100 includes a structure capable of reducing the parasitic capacitance between the stator 30 and the rotor 55 in order to solve electromagnetic interference problem (e.g., AM noise).

The drive motor 100 includes the shielding film 70 for shielding the parasitic capacitance between the stator 30 and the rotor 50. The shielding film 70 may be disposed between the stator coil 31 and the rotor 50.

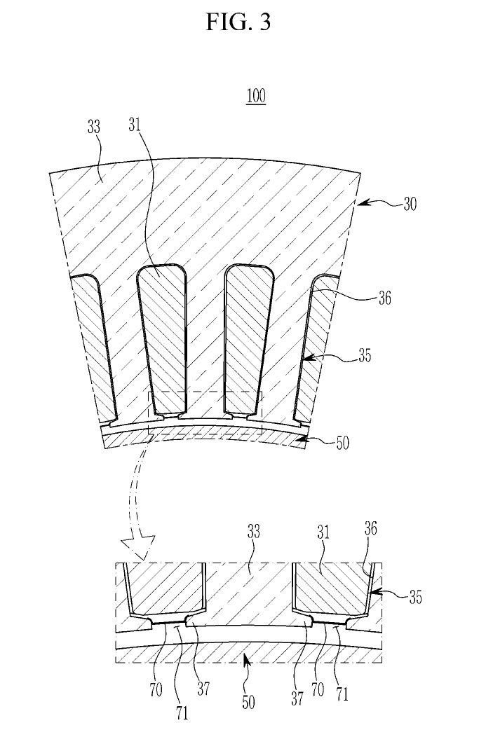

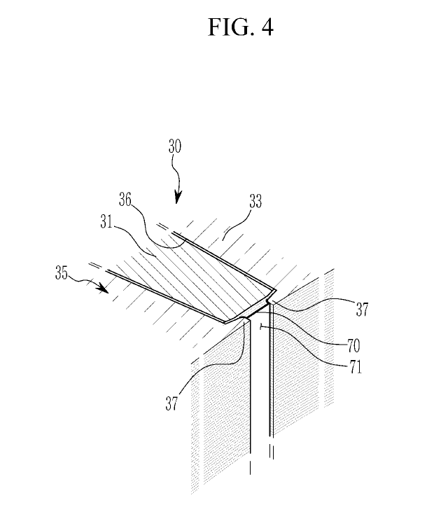

FIGS. 3 and 4 are views showing the shielding film applied to the drive motor according to an exemplary embodiment of the present disclosure.

Referring to FIGS. 1-4, the shielding film 70 may be formed in an opening area 71 between both ends of stator shoes 37 adjacent to each other. The shielding film 70 may seal or close the opening area 71 along the axial direction of the rotor 50 and may be attached to both ends of the neighboring stator shoes 37.

The shielding film 70 may be disposed as close as possible to the stator coil 31 in the opening area 71 between both ends of the neighboring stator shoes 37. Both side portions along the axial direction of the shielding film 70 may be adhered to both ends of the stator shoes 37 adjacent to each other through a structural adhesive.

The shielding film 70 may have electrical conductivity to prevent the parasitic capacitance between the stator coil 31 and the rotor 50, and may include a non-magnetic material that does not affect a magnetic flux between the stator 30 and the rotor 50.

The shielding film 70 may be made of an electrically conductive nonmagnetic material having a conductivity of 10⁶ (1/Ωm) or more and a magnetic permeability of 2 (H/m) or less. For example, the electrically conductive nonmagnetic material may be copper, aluminum, silver, gold, titanium, or tungsten.

The shielding film 70 may have a thickness of 0.1 to 0.3 mm For example, when a thickness of the shielding film 70 is less than 0.1 mm, it may be not easy to attach the shielding film to both ends of the stator shoes 37 and durability problems that the shielding film is torn by air pressure in the gap when the rotor 50 is rotated may occur.

When the thickness of the shielding film 70 exceeds 0.3 mm, a leakage magnetic flux between the stator 30 and the rotor 50 may change so that electromagnetic induction due to the changed leakage magnetic flux may cause eddy current loss (or copper loss).

Because the shielding film 70 is disposed in the opening area 71 of the stator coil 31 between the stator 30 and the rotor 50, the shielding film may shield the parasitic capacitance between the stator coil 31 and the rotor 50.

A magnitude of a parasitic capacitance between the stator coil 31 and the rotor 50 may be reduced so that the shaft current in the rotation shaft 51 is reduced by reducing a current delivered to the rotor 50.

As described above, the shielding film 70 may reduce the shaft current in the rotation shaft 51 so that it is possible to prevent bearing erosion damage caused by an abnormal discharge phenomenon in which an electric spark occurs and to mitigate electromagnetic interference (e.g., the AM noise) due to the shaft current.

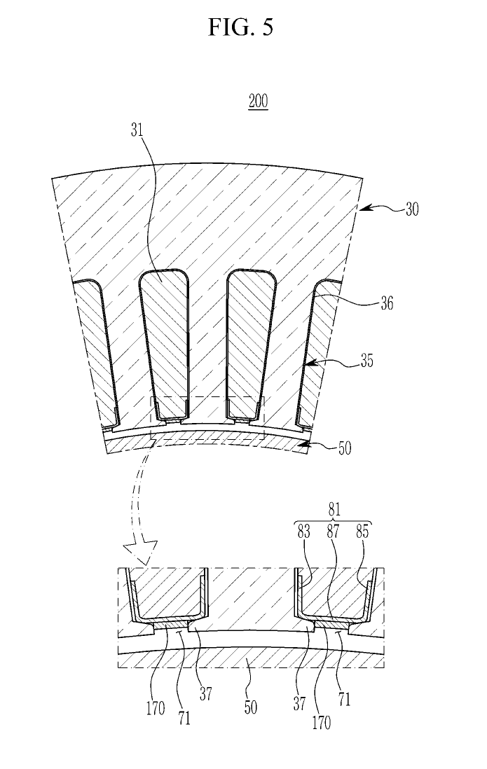

FIG. 5 is a view schematically showing a shielding structure of the drive motor according to another exemplary embodiment of the present disclosure. In FIG. 5, the same reference numerals as those in the above exemplary embodiment are given to the same elements as the elements of the exemplary embodiment.

Referring to FIG. 5, the drive motor 200 may include the stator 30 that is a basic structure and may further include a coil fixing member 81 for fixing the stator coil 31 in the slot 36 between the stator teeth 35.

The coil fixing member 81 may be referred to as a wedge in a relevant field of technology and may include an insulating material having electrical insulation. The coil fixing member 81 may be inserted in the slot 36 and the opening area 71 between both ends of the stator shoes 37 adjacent to each other, along the axial direction.

For example, the coil fixing member 81 may have a “C” cross-sectional shape. The coil fixing member 81 includes a first portion 83 for supporting one side stator tooth 35 in the slot 36, a second portion 85 for supporting a neighboring other side stator tooth 35 in the slot, and a third portion 87 located in the opening area 71 in the slot. The first portion 83, the second portion 85, and the third portion 87 may be integrally connected.

The shielding film 170 may be disposed on the coil fixing member 81 between the stator teeth 35 adjacent to each other. The shielding film may shield the parasitic capacitance between the stator coil 31 and the rotor 50.

The shielding film 170 may be attached to the coil fixing member 81 in the opening area 71 between both ends of neighboring stator shoes 37. The shielding film 170 may be attached on the third portion 87 of the coil fixing member 81 along the axial direction of the rotor 50 in the opening area 71 between both ends of the neighboring stator shoes 37. The shielding film 170 may be adhered to an opening surface of the third portion 87 along the axial direction of the rotor 50 through the structural adhesive.

In another exemplary embodiment of the present disclosure, the shielding film 170 may be attached to a surface that faces the gap and is constituted by the first portion, the second portion and the third portion along the axial direction of the rotor 50. In another exemplary embodiment of the present disclosure, the shielding film 170 may be attached to a surface that faces the slot 36 and is constituted by the first portion, the second portion and the third portion along the axial direction of the rotor 50. The shielding film 170 may be adhered to the surface that faces the gap or the surface that faces the slot 36 along the axial direction of the rotor 50 through the structural adhesive.

Another structure and another operation of the drive motor 200 according to another embodiment of the present disclosure are the same as those in the above exemplary embodiment, and thus a detailed description thereof will be omitted.

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

What is claimed is:

1. A drive motor for a vehicle, comprising:
a stator having a wound stator coil;
a rotor that is spaced from the stator by a gap and is rotatably disposed in the stator; and
a shielding film that is disposed between the stator coil and the rotor and is configured to shield a parasitic capacitance between the stator and the rotor.

2. The drive motor of claim 1, wherein the stator comprises:
stator teeth protruding in a radial direction at regular intervals along a circumferential direction; and
stator shoes integrally formed with the stator teeth and facing the rotor,
wherein the stator coil is wound on the stator tooth in a slot between the stator teeth, and
wherein the shielding film is disposed in an opening area between both ends of the stator shoes adjacent to each other.

3. The drive motor of claim 2, wherein the shielding film seals the opening area along an axial direction of the rotor and is attached to both ends of the stator shoes adjacent to each other.

4. The drive motor of claim 2, wherein the shielding film is made of an electrically conductive nonmagnetic material.

5. The drive motor of claim 4, wherein the shielding film is made of the electrically conductive nonmagnetic material having a conductivity of 10⁶ (1/Ωm) or more and a magnetic permeability of 2 (H/m) or less.

6. The drive motor of claim 4, wherein the shielding film is made of a material selected from the group consisting of: copper, aluminum, and silver.

7. The drive motor of claim 4, wherein a thickness of the shielding film is greater than or equal to 0.1 mm and less than or equal to 0.3 mm.

8. A drive motor for a vehicle, comprising:
a stator; and
a rotor,
wherein the stator includes stator teeth protruding in a radial direction and disposed between slots along a circumferential direction, stator shoes integrally formed with the stator teeth and facing the rotor, and a stator coil wound on a stator tooth of the stator teeth in the slots, and
wherein a shielding film is disposed in an opening area between both ends of the stator shoes adjacent to each other and is configured to shield a parasitic capacitance between the stator and the rotor.

9. The drive motor of claim 8, wherein the shielding film seals the opening area along an axial direction of the rotor and is attached to both ends of the stator shoes adjacent to each other.

10. The drive motor of claim 9, wherein the shielding film is made of an electrically conductive nonmagnetic material.

11. A drive motor for a vehicle, comprising:
a stator having a stator coil wound around a stator tooth of stator teeth that protrude in a radial direction and are disposed between slots along a circumferential direction;
a rotor that is spaced from the stator by a gap and is rotatably disposed in the stator;
a coil fixing member that is installed in a slot of the slots, is configured to fix the stator coil, and includes an insulating material; and
a shielding film that is disposed on the coil fixing member between the stator teeth adjacent to each other and is configured to shield a parasitic capacitance between the stator coil and the rotor.

12. The drive motor of claim 11, wherein the stator includes stator shoes integrally formed with the stator teeth and facing the rotor, and
wherein the shielding film is attached to the coil fixing member in an opening area between both ends of the stator shoes adjacent to each other.

13. The drive motor of claim 12, wherein the coil fixing member comprises:
a first portion supporting a first stator tooth of the stator teeth in the slot;
a second portion supporting a second stator tooth of the stator teeth that is adjacent to the first stator tooth in the slot; and
a third portion disposed in the opening area, and
wherein the shielding film is attached to an opening surface of the third portion along an axial direction of the rotor.

14. The drive motor of claim 11, wherein the stator includes stator shoes integrally formed with the stator teeth and facing the rotor,
wherein the coil fixing member comprises: a first portion supporting a first stator tooth of the stator teeth in the slot; a second portion supporting a second stator tooth of the stator teeth that is adjacent to the first stator tooth in the slot; and a third portion disposed in an opening area between both ends of the stator shoes adjacent to each other, and
wherein the shielding film is attached to a surface that faces the gap and is constituted by the first portion, the second portion and the third portion along an axial direction of the rotor.

15. The drive motor of claim 11, wherein the stator includes stator shoes integrally formed with the stator teeth and facing the rotor,
wherein the coil fixing member comprises: a first portion supporting a first stator tooth of the stator teeth in the slot; a second portion supporting a second stator tooth of the stator teeth that is adjacent to the first stator tooth in the slot; and a third portion disposed in an opening area between both ends of the stator shoes adjacent to each other, and
wherein the shielding film is attached to a surface that faces the slot and is constituted by the first portion, the second portion and the third portion along an axial direction of the rotor.

16. The drive motor of claim 11, wherein the shielding film is made of an electrically conductive nonmagnetic material.
